(19) United States
(12) Patent Application Publication
(10) Pub. No.: US 2016/0144520 A1
(43) Pub. Date: May 26, 2016

(54) RAZOR MODULE

(71) Applicant: TSUNG SHIH LEE, New Taipei City (TW)

(72) Inventor: TSUNG SHIH LEE, New Taipei City (TW)

(21) Appl. No.: 14/616,641

(22) Filed: Feb. 6, 2015

(30) Foreign Application Priority Data
Nov. 26, 2014 (TW) 103221037

(51) Int. Cl. B26B 21/52; B26B 21/14

(52) U.S. Cl. CPC B26B 21/521; B26B 21/14

(57) ABSTRACT

The present invention provides a razor module comprising a body unit and a cutter unit; the body unit has a button part comprising a guiding member, and a lever part comprising an elastic member; the cutter unit is formed with a connecting element having a buckle groove thereon; with the normal situation that the lever part clamps the buckle groove, the button part begins to be pressed by the user and makes the elastic member and the guiding member contract inwardly to produce an elastic energy storage, and meanwhile, the lever part releases the connecting element for the replacement of the cutter unit; when the user stops pressing the button part, the lever part and the button part reposition again due to the flexibility of the elastic member and the guiding member, so as to achieve effects such as easy operation, convenient and quick replacement.

### BACKGROUND OF THE INVENTION

1. Field of the Invention

The present invention relates to a razor module, and more particularly to a razor module providing safety and convenience in the replacement of a cutter unit thereof.

2. The Related Art

Conventional razors can be classified as being either single-blade or multi-blade, both of which have good performance on shaving. However, the safety and the convenience on operation are not improved with the technology advanced.

Further, people usually get cut easily when they are replacing a cutter unit of the conventional razor because their fingers need to hold the cutter unit having sharp blades exposed outside. When the cutter unit is replaced, there are still several assembly and disassembly processes to follow, therefore makes the risk of being cut greatly enhanced.

### SUMMARY OF THE INVENTION

Accordingly, an object of the present invention is to provide a razor module which performs the replacement of the cutter unit just by pressing buttons instead of following several assembly and disassembly processes, and thus decreases risks of cutting user's skin and also increases the convenience on operation.

Another object of the present invention is to provide a razor module which needs to be operated for replacement of the cutter unit by two fingers respectively pressing different buttons at the same time so as to avoid getting cut when the unexpected disengagement of the cutter unit occurs by mistakenly touching and thus to achieve safety effect.

Another object of the present invention is to provide a razor module which has relatively low manufacturing costs, suitable for large-scale producing, thus to meet the requirement of economic efficiency and market demand.

To attain this, the razor module comprises a body unit, a cutter unit and a holding unit; wherein the body unit has a shell part, a button part and a lever part; the shell part is composed of a first shell and a second shell, wherein the first shell and the second shell are respectively provided with a first opening and a second opening that correspond with each other; the button part includes a first button and a second button, respectively mounted in the first opening and the second opening; the shell part further comprises four brackets therein, with each two in pairs respectively mounted on inside walls of the first shell and the second shell; the brackets in pairs respectively mounted on the first and second shell are extended to come in contact with each other, and a circular notch is formed therebetween for the assembly of the lever part; each of the first and second buttons is formed integrally with a guiding member embodied as an extension spring having flexibility and a shape of string, one end of which is formed with the pushing portion and the other end is connected with a holder secured on an inside wall of the shell part so as to provide a movement guidance and an impact buffer for the first and second buttons being pressed; the lever part comprises a first lever member, a second lever member and an elastic member; the first lever member integrally forms an outer support member about a middle part thereof; the outer support member is shaped as a cylinder, both opposite ends of which are extended beyond an edge of the first lever member for being assembled in the circular notch of the brackets; the outer support member forms a hollow portion between the opposite ends, and two recesses are formed face to face on side walls of the outer support member along edges of the hollow portion for the assembly of the second lever member; the second lever member integrally forms an inner support member about a middle part thereof; the inner support member is shaped as a cylinder, both opposite ends of which are extended beyond an edge of the second lever member for being assembled in the recesses of the first lever member, wherein the inner support member has a radius slightly smaller than a radius of the recesses so that the second lever member has a pivotal mechanism in accordance with the first lever member in the preferred form shown as two opposite ends of the inner support member of the second lever member pivotably received in the two recesses of the first lever member; the first lever member further integrally forms a first fastener and a first receiving slot, respectively located about opposite end parts thereof; the second lever member further integrally forms a second fastener and a second receiving slot, respectively located about opposite end parts thereof; the first fastener is aligned correspondingly to the second fastener, while the first receiving slot is aligned correspondingly to the second receiving slot, wherein the first and second fasteners are formed by elevating the surfaces of the first and second lever members to abut with each other; the first and second receiving slots are formed by sinking into the surfaces of the first and second lever members to cooperatively fix the elastic member therebetween, i.e., the elastic member has opposite ends respectively secured in the first and second receiving slots for the fixation; the first and second receiving slots forms an abutting wall therearound to be abutted by the pushing portion of the button part for establishing control over the elastic member via the button part; wherein the cutter unit is formed with a connecting element extended toward the body unit, wherein the connecting element is plate shaped and has a buckle groove thereon for being clamped by the first and second fasteners when assembled; and wherein the holding unit is disposed on the body unit and located opposite the cutter unit and designed as a long-handled shape for fitting easily in the hand; with the normal situation that the first and second fasteners abut with each other to clamp the buckle groove, the button part begins to be pressed by the user and makes the elastic member and the guiding member contract inwardly to produce an elastic energy storage, and meanwhile, the first and second fasteners separate from each other to release the connecting element for the replacement of the cutter unit; when the user stops pressing the button part, the first and second fasteners and the button part reposition again due to the flexibility of the elastic member and the guiding member, so as to achieve effects such as easy operation, convenient and quick replacement.

In accordance with the present invention, each of the first and second buttons has a pressing portion and a pushing portion, wherein the pressing portion is arranged outward via the first and second openings for easy operation; the pushing portion located inside the shell part has an outline larger than an outline of the first and second openings and abuts on an inside wall of the shell part so as to prevent the button part from slipping out of the first and second openings.

In accordance with the present invention, a plurality of bumps are included between the pushing portion and the abutting wall, with the bumps positioned on the pushing portion and abutted on the pushing portion precisely, so as to completely transmit the pressure force acting on the button part to the elastic member while the button part is pressed by the user.

### BRIEF DESCRIPTION OF THE DRAWINGS

FIG. 1 is a perspective view of the razor module according to the first embodiment of the present invention;

FIG. 2 is an exploded view illustrating FIG. 1;

FIG. 3 is a partial perspective view according to the first embodiment of the present invention;

FIG. 4 is a perspective view of a lever part according to the first embodiment of the present invention;

FIG. 5 is a perspective view of a cutter cover according to the first embodiment of the present invention;

FIG. 6 is an exploded view of a cutter unit according to the second embodiment of the present invention;

FIG. 7 is an assembled view illustrating FIG. 6.

### DESCRIPTION OF THE PREFERRED EMBODIMENTS

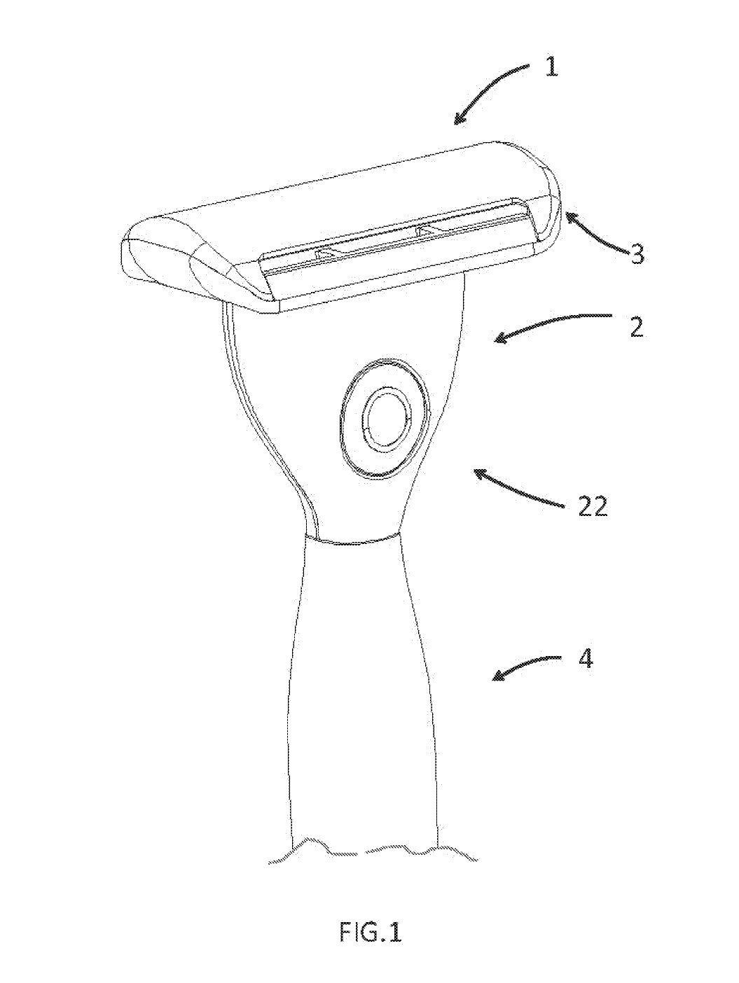

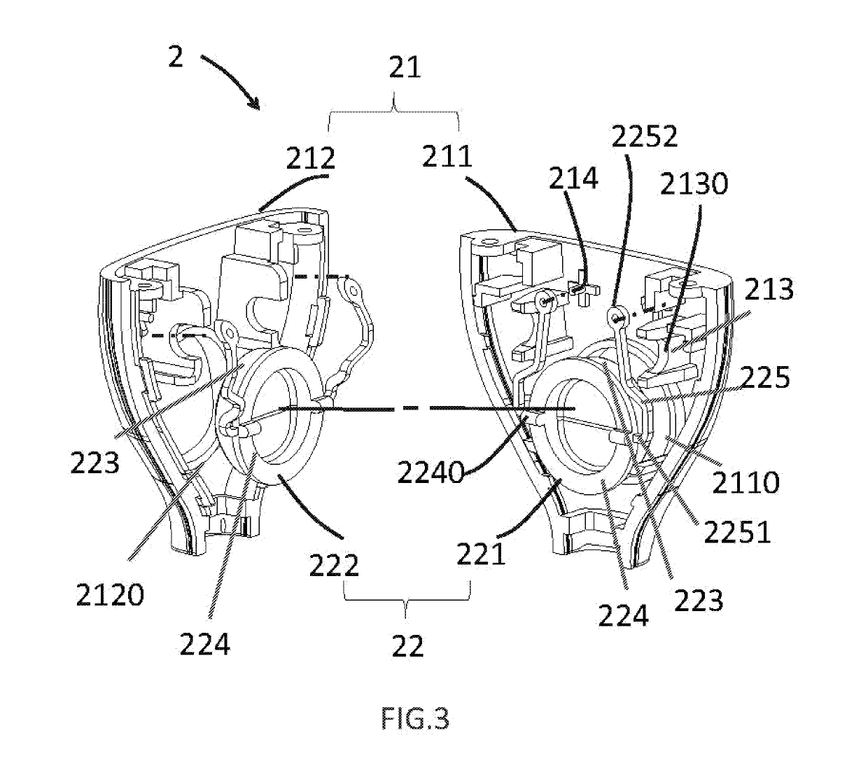

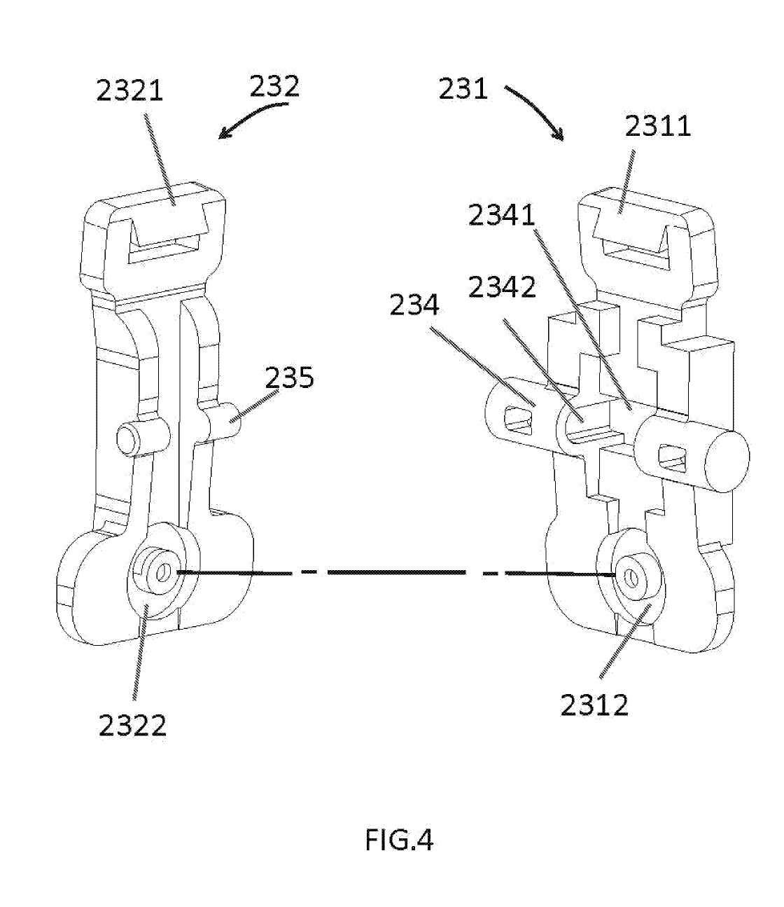

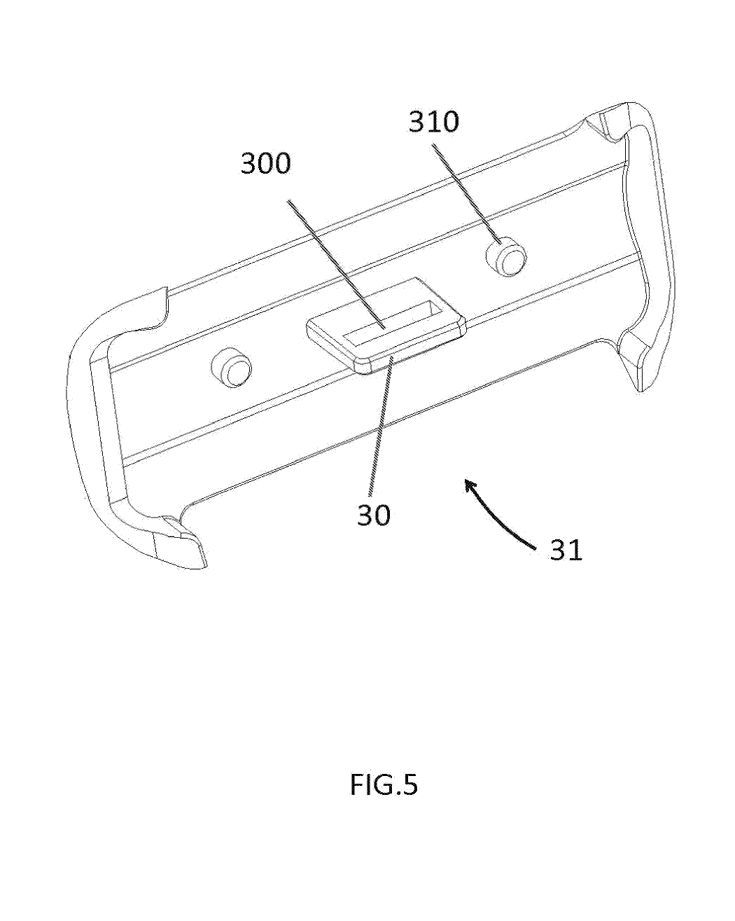

Referring to FIGS. 1 to 5 as the first embodiment of the present invention, a razor module 1 comprises a body unit 2, a cutter unit 3 and a holding unit 4. The cutter unit 3 and the holding unit 4 are disposed on opposite sides of the body unit 2, respectively. The holding unit 4 is designed as a long-handled shape for fitting easily in the hand.

The body unit 2 has a shell part 21, a button part 22 and a lever part 23. The shell part 21 is composed of a first shell 211 and a second shell 212, wherein the first shell 211 and the second shell 212 are respectively provided with a first opening 2110 and a second opening 2120 that correspond with each other; the button part 22 includes a first button 221 and a second button 222, respectively mounted in the first opening 2110 and the second opening 2120. Each of the first and second buttons 221,222 has a pressing portion 223 and a pushing portion 224, wherein the pressing portion 223 is arranged outward via the first and second openings 2110,2120 for easy operation; the pushing portion 224 located inside the shell part 21 has an outline larger than an outline of the first and second openings 2110,2120 and abuts on an inside wall of the shell part 21 so as to prevent the button part 22 from slipping out of the first and second openings 2110,2120. Furthermore, each of the first and second buttons 221,222 is formed integrally with a guiding member 225 embodied as an extension spring having flexibility and a shape of string, one end of which is formed with the pushing portion 224 and the other end is connected with a holder 214 secured on an inside wall of the shell part 21 so as to provide a movement guidance and an impact buffer for the first and second buttons 221,222 being pressed.

The shell part 21 further comprises four brackets 213 therein, with each two in pairs respectively mounted on inside walls of the first shell 211 and the second shell 212. The brackets 213 in pairs respectively mounted on the first and second shell 211,212 are extended to come in contact with each other, and a circular notch 2130 is formed therebetween for the assembly of the lever part 23.

The lever part 23 comprises a first lever member 231, a second lever member 232 and an elastic member 233. The first lever member 231 integrally forms an outer support member 234 about a middle part thereof. The outer support member 234 is shaped as a cylinder, both opposite ends of which are extended beyond an edge of the first lever member 231 for being assembled in the circular notch 2130 of the brackets 213. The outer support member 234 forms a hollow portion 2341 between the opposite ends, and two recesses 2342 are formed face to face on side walls of the outer support member 234 along edges of the hollow portion 2341 for the assembly of the second lever member 232. The second lever member 232 integrally forms an inner support member 235 about a middle part thereof. The inner support member 235 is shaped as a cylinder, both opposite ends of which are extended beyond an edge of the second lever member 232 for being assembled in the recesses 2342 of the first lever member 231, wherein the inner support member 235 has a radius slightly smaller than a radius of the recesses 2342 so that the second lever member 232 has a pivotal mechanism in accordance with the first lever member 231 in the preferred form shown as two opposite ends of the inner support member 235 of the second lever member 232 pivotably received in the two recesses 2342 of the first lever member 231.

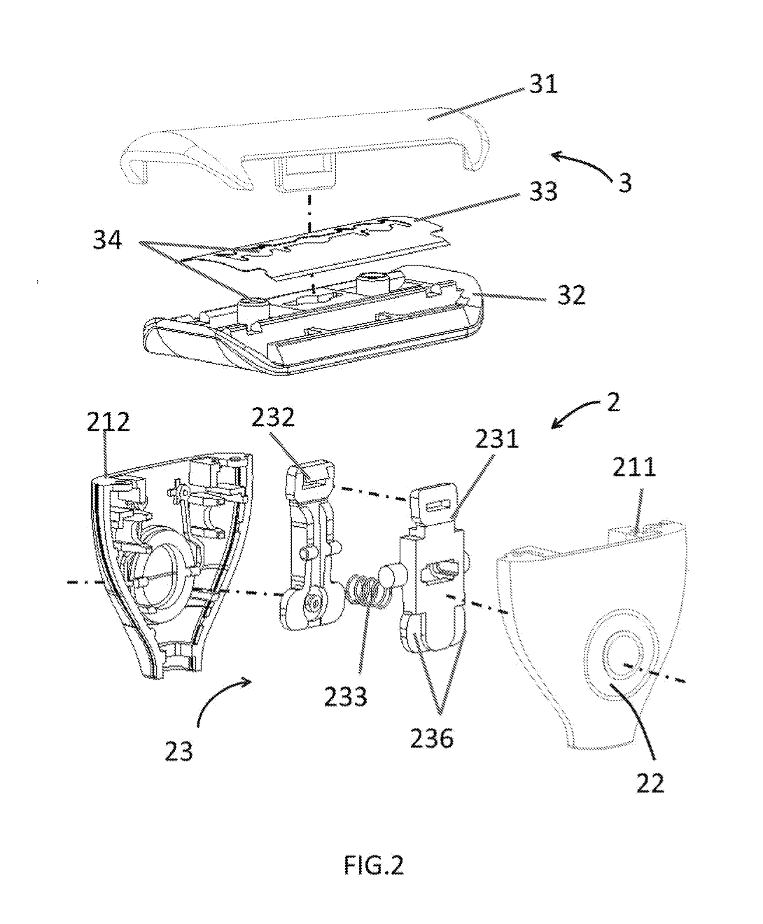

The first lever member 231 further integrally forms a first fastener 2311 and a first receiving slot 2312, respectively located about opposite end parts thereof. Similarly, the second lever member 232 further integrally forms a second fastener 2321 and a second receiving slot 2322, respectively located about opposite end parts thereof. The first fastener 2311 is aligned correspondingly to the second fastener 2311, while the first receiving slot 2312 is aligned correspondingly to the second receiving slot 2322, wherein the first and second fasteners 2311, 2321 are formed by elevating the surfaces of the first and second lever members 231,232 to abut with each other. Conversely, the first and second receiving slots 2312,2322 are formed by sinking into the surfaces of the first and second lever members 231,232 to cooperatively fix the elastic member 233 therebetween, i.e., the elastic member 233 defined with a compression spring having opposite ends respectively secured in the first and second receiving slots 2312,2322 for the fixation. Furthermore, the first and second receiving slots 2312, 2322 forms an abutting wall 236 therearound, with reference to FIG. 2, to be abutted by the pushing portion 224 of the button part 22 for establishing control over the elastic member 233 via the button part 22.

Preferably, a plurality of bumps 2240 could be included between the pushing portion 224 and the abutting wall 236, with the bumps 2240 positioned on the pushing portion 224 and abutted on the pushing portion 224 precisely, so as to completely transmit the pressure force acting on the button part 22 to the elastic member 233 while the button part 22 is pressed by the user.

The elastic member 233 is defined as the compression spring in this embodiment but not limited to the spring; components having the restoring force are included in the scope of the present invention.

Next, the cutter unit 3 is formed with a connecting element 30 extended toward the body unit 2, wherein the connecting element 30 is plate shaped and has a buckle groove 300 thereon for being clamped by the first and second fasteners 2311,2321 when assembled.

With the normal situation that the first and second fasteners 2311,2321 abut with each other to clamp the buckle groove 300, the button part 22 begins to be pressed by the user and makes the elastic member 233 and the guiding member 225 contract inwardly to produce an elastic energy storage, and meanwhile, the first and second fasteners 2311,2321 separate from each other to release the connecting element 30 for the replacement of the cutter unit 3; when the user stops pressing the button part 22, the first and second fasteners 2311,2321 and the button part 22 reposition again due to the flexibility of the elastic member 223 and the guiding member 225, so as to achieve effects such as convenient operation and quick replacement.

Compared with conventional razors, the razor module 1 of the present invention needs to be operated for replacement of the cutter unit 3 by two fingers respectively pressing different buttons 221,222 at the same time so as to avoid getting cut when the unexpected disengagement of the cutter unit 3 occurs by mistakenly touching and thus to achieve safety effect.

In addition, the razor module 1 of the present invention has relatively low manufacturing costs, suitable for large-scale producing to meet the requirement of economic efficiency and market demand.

As above, the cutter unit 3 further comprises a cutter cover 31, a cutter base 32 and a blade 33 secured between the cutter cover 31 and the cutter base 32. A second positioning member 310 is mounted on the cutter cover 31 and located on opposite sides of the connecting element 30. Accordingly, the blade 33 and the cutter base 32 are formed with penetrating holes 34 to provide the connecting element 30 and the second positioning member 310 penetrate therethrough, with reference to FIG. 2, wherein the penetrating holes 34 have a width same as a width of the penetrating holes 34 and the second positioning member 310 for firmly combining the cutter cover 31, the blade 33 and the cutter base 32 together in order as the cutter unit 3.

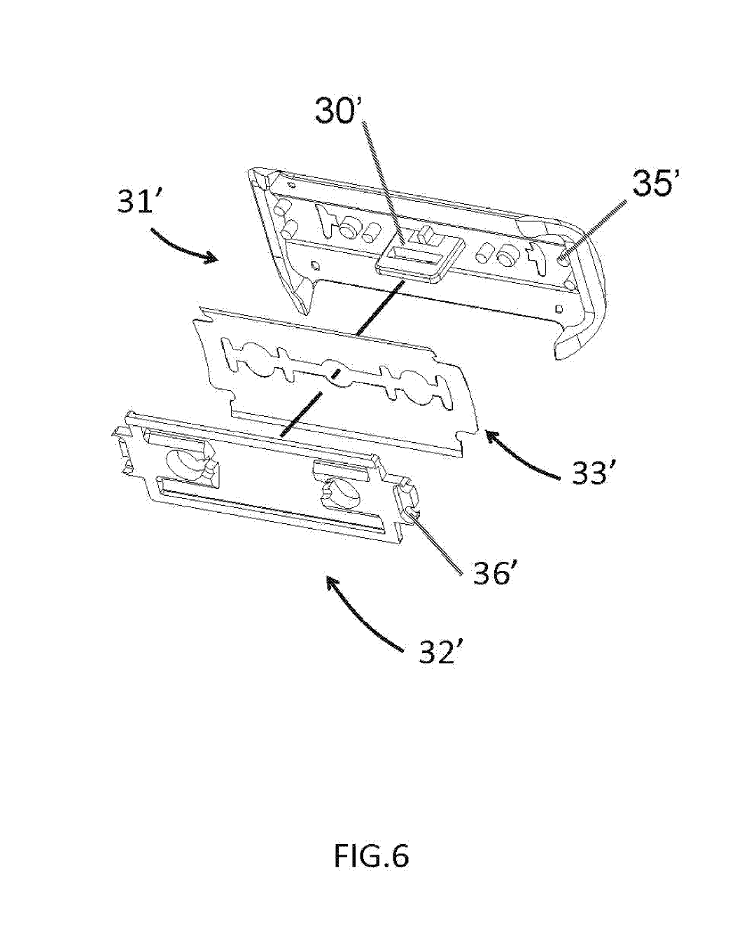

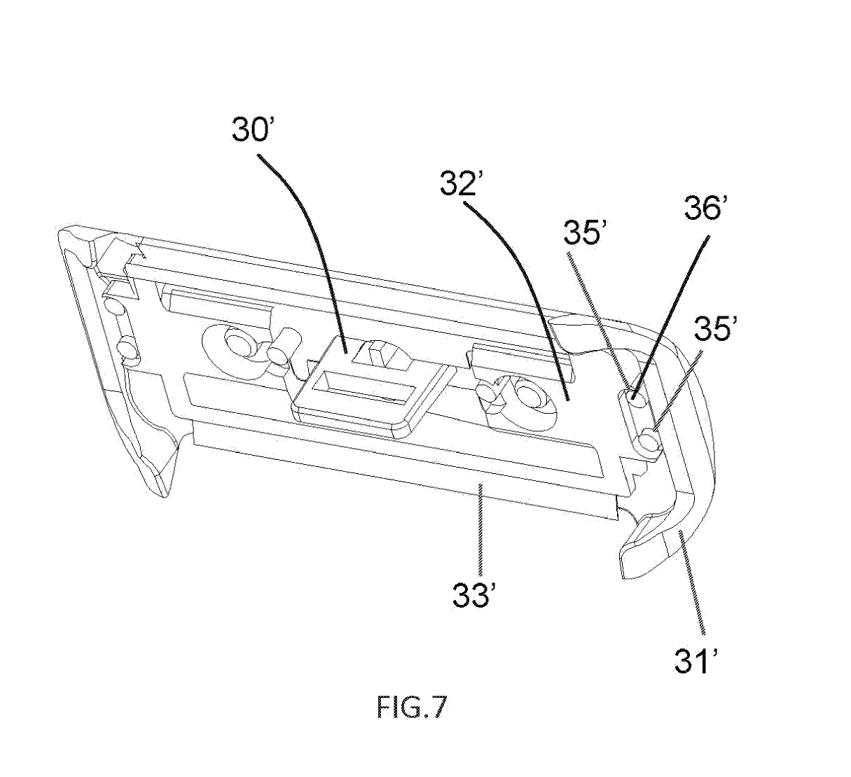

With reference to FIGS. 6 and 7 as the second embodiment of the present invention, a connecting element 30′ is also included in this embodiment, which is same as the connecting element 30 in the first embodiment; the second embodiment differs in that a third positioning member 35′ and a positioning hole 36′ are respectively mounted on a cutter cover 31′ and a cutter base 32′, wherein the third positioning member 35′ are located on opposite sides of the connecting element 30′, and the positioning hole 36′ has a width same as a width of the third positioning member 35′ so that a blade 33′ could be fixed between the cutter cover 31′ and the cutter base 32′ more firmly and precisely.

Furthermore, once the assembly of the cutter cover 31′ and the cutter base 32′ has been completed, some techniques such as ultrasonic welding or hot melting may also be incorporated with plastic welding for the further strengthening for the fixation of the positioning hole 36′ and the third positioning member 35′.

It is understood that the invention may be embodied in other forms within the scope of the claims. Thus the present examples and embodiments are to be considered in all respects as illustrative, and not restrictive, of the invention defined by the claims.

What is claimed is:

1. A razor module, comprising a body unit, a cutter unit and a holding unit;
wherein the body unit has a shell part, a button part and a lever part; the shell part is composed of a first shell and a second shell, wherein the first shell and the second shell are respectively provided with a first opening and a second opening that correspond with each other; the button part includes a first button and a second button, respectively mounted in the first opening and the second opening; the shell part further comprises four brackets therein, with each two in pairs respectively mounted on inside walls of the first shell and the second shell; the brackets in pairs respectively mounted on the first and second shell are extended to come in contact with each other, and a circular notch is formed therebetween for the assembly of the lever part; each of the first and second buttons is formed integrally with a guiding member embodied as an extension spring having flexibility and a shape of string, one end of which is formed with the pushing portion and the other end is connected with a holder secured on an inside wall of the shell part so as to provide a movement guidance and an impact buffer for the first and second buttons being pressed; the lever part comprises a first lever member, a second lever member and an elastic member; the first lever member integrally forms an outer support member about a middle part thereof; the outer support member is shaped as a cylinder, both opposite ends of which are extended beyond an edge of the first lever member for being assembled in the circular notch of the brackets;
the outer support member forms a hollow portion between the opposite ends, and two recesses are formed face to face on side walls of the outer support member along edges of the hollow portion for the assembly of the second lever member; the second lever member integrally forms an inner support member about a middle part thereof; the inner support member is shaped as a cylinder, both opposite ends of which are extended beyond an edge of the second lever member for being assembled in the recesses of the first lever member, wherein the inner support member has a radius slightly smaller than a radius of the recesses so that the second lever member has a pivotal mechanism in accordance with the first lever member in the preferred form shown as two opposite ends of the inner support member of the second lever member pivotably received in the two recesses of the first lever member; the first lever member further integrally forms a first fastener and a first receiving slot, respectively located about opposite end parts thereof; the second lever member further integrally forms a second fastener and a second receiving slot, respectively located about opposite end parts thereof; the first fastener is aligned correspondingly to the second fastener, while the first receiving slot is aligned correspondingly to the second receiving slot, wherein the first and second fasteners are formed by elevating the surfaces of the first and second lever members to abut with each other; the first and second receiving slots are formed by sinking into the surfaces of the first and second lever members to cooperatively fix the elastic member therebetween, i.e., the elastic member has opposite ends respectively secured in the first and second receiving slots for the fixation; the first and second receiving slots forms an abutting wall therearound to be abutted by the pushing portion of the button part for establishing control over the elastic member via the button part;
wherein the cutter unit is formed with a connecting element extended toward the body unit, wherein the connecting element is plate shaped and has a buckle groove thereon for being clamped by the first and second fasteners when assembled; and
wherein the holding unit is disposed on the body unit and located opposite the cutter unit and designed as a long-handled shape for fitting easily in the hand;
with the normal situation that the first and second fasteners abut with each other to clamp the buckle groove, the button part begins to be pressed by the user and makes the elastic member and the guiding member contract inwardly to produce an elastic energy storage, and meanwhile, the first and second fasteners separate from each other to release the connecting element for the replacement of the cutter unit; when the user stops pressing the button part, the first and second fasteners and the button part reposition again due to the flexibility of the elastic member and the guiding member, so as to achieve effects such as easy operation, convenient and quick replacement.

2. The razor module of claim 1, wherein each of the first and second buttons has a pressing portion and a pushing portion, wherein the pressing portion is arranged outward via the first and second openings for easy operation; the pushing portion located inside the shell part has an outline larger than an outline of the first and second openings and abuts on an inside wall of the shell part so as to prevent the button part from slipping out of the first and second openings.

3. The razor module of claim 2, wherein a plurality of bumps are included between the pushing portion and the abutting wall, with the bumps positioned on the pushing portion and abutted on the pushing portion precisely, so as to completely transmit the pressure force acting on the button part to the elastic member while the button part is pressed by the user.

4. The razor module of claim 1, wherein the elastic member is defined as a compression spring.

5. A razor module, comprising a body unit, a cutter unit and a holding unit;
wherein the body unit has a shell part, a button part and a lever part; the lever part comprises a first lever member, a second lever member and an elastic member; the first lever member forms an outer support member about a middle part thereof to assemble with the shell part; the first lever member further integrally forms a first fastener and a first receiving slot; the second lever member integrally forms an inner support member about a middle part thereof to actively assemble with the first lever member; the second lever member further integrally forms a second fastener and a second receiving slot, respectively located about opposite end parts thereof; wherein the first and second fasteners are formed by elevating the surfaces of the first and second lever members to abut with each other; the first and second receiving slots are formed by sinking into the surfaces of the first and second lever members to cooperatively fix the elastic member therebetween; the first and second receiving slots forms an abutting wall therearound to be abutted by the button part;
wherein the cutter unit is formed with a connecting element extended toward the body unit, wherein the connecting element is plate shaped and has a buckle groove thereon for being clamped by the first and second fasteners when assembled; the cutter unit further comprises a cutter cover, a cutter base and a blade secured between the cutter cover and the cutter base; a second positioning member is mounted on the cutter cover and located on opposite sides of the connecting element; the blade and the cutter base are formed with penetrating holes to provide the connecting element and the second positioning member penetrate therethrough, wherein the penetrating holes have a width same as a width of the penetrating holes and the second positioning member for firmly combining the cutter cover, the blade and the cutter base in order as the cutter unit; and
wherein the holding unit is disposed on the body unit and located opposite the cutter unit and designed as a long-handled shape for fitting easily in the hand.

6. The razor module of claim 5, wherein the button part is formed integrally with guiding members that is an extension spring having flexibility and a shape of string, one end of which is formed with the pushing portion and the other end is connected with a holder secured on an inside wall of the shell part so as to provide a movement guidance and an impact buffer for the first and second buttons being pressed, wherein the elastic member is defined as a compression spring.

7. The razor module of claim 5, wherein a plurality of bumps are included between the pushing portion and the abutting wall, wherein the bumps are positioned on the pushing portion and abutted on the pushing portion precisely, so as to completely transmit the pressure force acting on the button part to the elastic member while the button part is pressed by the user.

8. A razor module, comprising a body unit, a cutter unit and a holding unit;
wherein the body unit has a shell part, a button part and a lever part; the lever part comprises a first lever member, a second lever member and an elastic member; the first lever member forms an outer support member about a middle part thereof to assemble with the shell part; the first lever member further integrally forms a first fastener and a first receiving slot; the second lever member integrally forms an inner support member about a middle part thereof to actively assemble with the first lever member; the second lever member further integrally forms a second fastener and a second receiving slot, respectively located about opposite end parts thereof; wherein the first and second fasteners are formed by elevating the surfaces of the first and second lever members to abut with each other; the first and second receiving slots are formed by sinking into the surfaces of the first and second lever members to cooperatively fix the elastic member therebetween; the first and second receiving slots forms an abutting wall therearound to be abutted by the button part;
wherein the cutter unit is formed with a connecting element extended toward the body unit, wherein the connecting element is plate shaped and has a buckle groove thereon for being clamped by the first and second fasteners when assembled; the cutter unit further comprises a cutter cover, a cutter base and a blade secured between the cutter cover and the cutter base; a third positioning member and a positioning hole are respectively mounted on the cutter cover and the cutter base, wherein the third positioning member are located on opposite sides of the connecting element, and the positioning hole has a width same as a width of the third positioning member so that the blade could be fixed between the cutter cover and the cutter base more firmly and precisely; and
wherein the holding unit is disposed on the body unit and located opposite the cutter unit and designed as a long-handled shape for fitting easily in the hand.

9. The razor module of claim 8, wherein the button part is formed integrally with guiding members that is an extension spring having flexibility and a shape of string, one end of which is formed with the pushing portion and the other end is connected with a holder secured on an inside wall of the shell part so as to provide a movement guidance and an impact buffer for the first and second buttons being pressed, wherein the elastic member is defined as a compression spring; and wherein a plurality of bumps are included between the pushing portion and the abutting wall, wherein the bumps are positioned on the pushing portion and abutted on the pushing portion precisely, so as to completely transmit the pressure force acting on the button part to the elastic member while the button part is pressed by the user.

10. The razor module of claim 8, wherein once the assembly of the cutter cover and the cutter base has been completed, some techniques such as ultrasonic welding or hot melting may also be incorporated with plastic welding for the further strengthening for the fixation of the positioning hole and the third positioning member.
